(19) United States
(12) Patent Application Publication
(10) Pub. No.: US 2010/0283595 A1
(43) Pub. Date: Nov. 11, 2010

(54) WEAR INDICATOR HAVING A TEMPERATURE SENSOR

(75) Inventors: Jorg Korecki, Aidlingen (DE); Marco Schock, Renningen (DE); Sebastian Kappel, Horb (DE)

Correspondence Address: BACHMAN & LAPOINTE, P.C., 900 CHAPEL STREET, SUITE 1201, NEW HAVEN, CT, 06510, US

(73) Assignee: PEX KABELTECHNIK GMBH, Herrenberg-Gultstein (DE)

(21) Appl. No.: 12/519,279

(22) PCT Filed: Dec. 13, 2007
(86) PCT No.: PCT/EP07/10926

§ 371 Date: Apr. 19, 2010

(30) Foreign Application Priority Data
Dec. 15, 2006 (DE) 10 2006 059 785.0

(51) Int. Cl. B60Q 1/00

(52) U.S. Cl. 340/454

(57) ABSTRACT

In a braking system for a vehicle, having at least one brake pad, with which at least one wear indicator is possibly associated, at least one temperature sensor (6) should be associated with the braking system and/or the wear indicator.

The invention relates to a braking system for a vehicle having at least one brake pad, which may have at least one associated wear indicator, with the braking system and/or the wear indicator having at least one associated temperature sensor.

### PRIOR ART

Wear indicators for brake pads are known and are commercially available in many forms and embodiments. They are used to monitor the wear of the brake pads and to transmit a signal to the driver as early as possible that the brake pads should be replaced. In this case, the brake pad generally has an associated wear body in which a contact element, generally an electrical conductor, is located. When the surface of this wear body is ground off by the opposing brake body, the opposing brake body also comes into contact with the contact element after a predetermined wear depth, in such a way that a signal is emitted via the contact element to the vehicle monitoring system, indicating that the brake pad has reached a specific wear level.

In order to allow step-by-step detection of the wear of the pad which can wear, DE 100 22 067 A1 provides that a second electrical conductor is arranged within the wear body, is electrically connected to a wear loop, and its free end ends at a distance from the wear surface which is less than the distance of the wear loop.

In DE 40 21 568 A1, two electrical conductors are insert-molded in an insert part, and this insert part is then inserted into an injection mold and is insert-molded to form an integral warning pellet.

DE 102 53 329 A1 discloses an apparatus for monitoring the wear of a brake pad by means of at least one contact element which is guided in a sensor, with the sensor having a slot for insertion of an electrical conductor which is passed back through a channel in a wear body.

Furthermore DE 698 24 413 P2 discloses a method and an apparatus for indication of the amount of brake pad material in a drum brake assembly, in which the brake pad has a first and a second associated temperature sensor, with the temperature itself being used as an indication of a worn brake pad. This sensor is located at a different distance form the wear surface of the brake pad, and measures the temperature of the brake pad at its respective location in the pad. The time which it takes for each sensor to reach a specific predetermined temperature is likewise measured, and the amount of wear in the brake pad is monitored on the basis of the ratio of these two times. This method is inaccurate and is subject to considerable faults. having one or more contact links, which can be interrupted by friction erosion, and a temperature sensor, the two of which are arranged in a single multistep sleeve which fits into a through-hole in a brake jaw with its brake pad, and be screwed between the brake pad and the brake jaw, or can be pressed into the brake pad by means of a suitable notch connection.

### OBJECT

The object to the present invention is to provide a braking system of the type mentioned above in which a brake with or without a commercially available wear indicator is additionally subject to monitoring.

### ACHIEVEMENT OF THE OBJECT

In order to achieve the object, the at least one temperature sensor has at least one associated cable run of an indicator cable.

The actual monitoring of the brake pad wear is carried out as before by the wear indicator, for example electrically. The indicator cable is therefore that cable which emits the actual signal when the brake pad falls below a predetermined thickness. However, the temperature around this wear indicator is also monitored. If a predetermined temperature is exceeded, at which it can be expected that parts of the brake could suffer considerably or the operation could be considerably adversely affected, this is determined via the temperature sensor, and is passed to a monitoring unit, possibly having a signal store. The temperature sensor also, of course, determines a rise in the temperature in the entire braking system, assuming that this temperature rise also extends to the area of the wear indicator. In a corresponding manner, this temperature indicator can also determine whether, for example, a wheel bearing has been damaged or whether there is any other fault in the brake leading to a temperature increase.

By the association of the temperature sensor with a cable run of the indicator cable, which is generally likewise heated in the same way as the area surrounding the brake itself, it is also possible to tap off the temperature from this particular indicator cable. In this case, a specific housing is provided, which fixes the temperature sensor with respect to the indicator cable. By way of example, this housing may be in two parts and may be clipped onto the indicator cable. This two-part housing can be fixed in particular by an attachment element, for example a shrink-sleeve section.

In a further exemplary embodiment of the invention, the temperature sensor is itself intended to be integrated in the wear indicator. This means that it determines the temperature increase of the brake, and passes this signal to the monitoring unit mentioned above. By way of example, in this case, the temperature sensor may be arranged within a loop which is formed by the actual indicator cable. One advantage of this arrangement is that the connecting cable between the temperature sensor and its signal store or its monitoring unit can be passed between the cable runs of the indicator cable from the wear indicator. In this case, a single cable sheath is sufficient for a connecting cable and indicator cable.

As mentioned above, the connecting cable and indicator cable should be passed together to a signal store or to a monitoring unit. However, if it is intended to monitor a plurality of braking systems, particularly as is the case with multiple-axle vehicles, then it may be advisable to connect a multiplexer between the monitoring unit and the braking system. All the lines from the braking systems open in this multiplexer, and are checked by the multiplexer at periodic intervals or continuously. In this case, a single line may be sufficient, via which the corresponding checked signals are then each passed to the monitoring unit and to the signal store.

The present invention also generally covers the method in which the temperature of the wear indictor itself and/or of its peripherals and/or of the indicator cable is monitored.

Furthermore, protection is also sought for the actual wear indicator, in which an indicator cable is located in a housing, with the housing and/or the indicator cable having an associated temperature sensor, and with the temperature sensor being associated with at least one cable run of the indicator cable.

### DESCRIPTION OF THE FIGURES

Further advantages, features and details of the invention will become evident from the following description of preferred exemplary embodiments and from the drawing, in which:

FIG. 1 shows a longitudinal section through a wear indicator according to the invention having an integrated temperature sensor;

FIG. 2 shows a side view of a wear indicator having a temperature detection device which is associated with an indicator cable and is illustrated in the form of a cross section;

FIG. 3 shows a cross section, illustrated enlarged, through a part of the temperature detection device shown in FIG. 2, along the line III-III;

FIG. 4 shows a plan view of a signal transmission unit for signals from a plurality of wear indicators and temperature detection units.

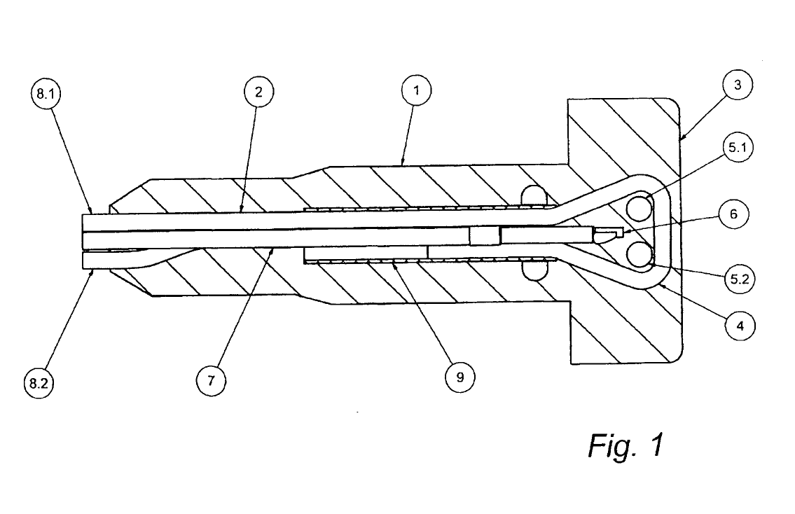

FIG. 1 illustrates a housing 1 of a wear indicator according to the invention, in which housing 1 an indicator cable 2 is located. Close to one end surface 3, this indicator cable 2 forms a loop 4 which is passed around corresponding guides 5.1 and 5.2.

According to the invention, a temperature sensor 6 which detects the temperature in the area of the loop 4 is located in the loop 4. The corresponding temperature signals are supplied via a connecting cable 7 to a signal store, which is not shown in any more detail. The unit comprising the indicator cable 2 with the two cable runs 8.1 and 8.2, the connecting cable 7 and the temperature sensor 6 is held together by a clamping element 9 and is jointly insert-molded, as a result of which this unit is then integrated in the housing 1.

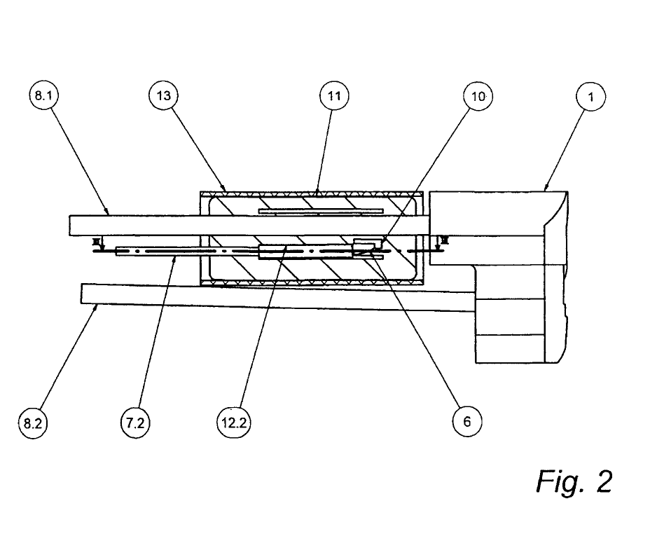

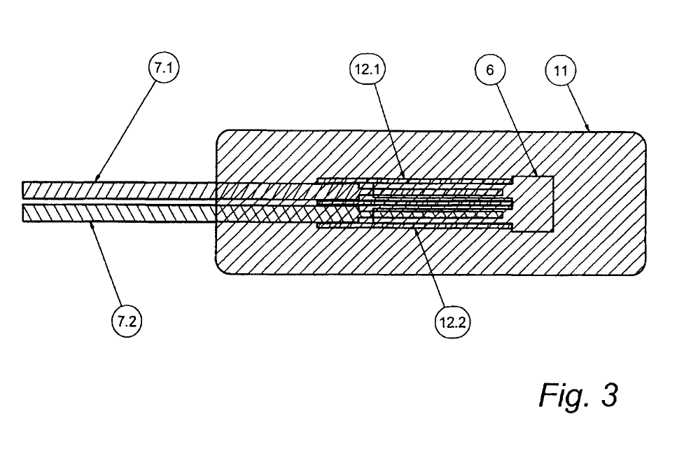

According to the exemplary embodiment of the present invention as shown in FIGS. 2 and 3, the temperature sensor 6 is located outside the housing 1 of the wear indicator. However, it is associated with a cable run 8.1 of the indicator cable 2, for which purpose it is located in a space 10 in a housing 11. Two connecting cables 7.1 and 7.2 are also routed in this housing 11, and are connected to the temperature sensor 6. A respective insulator 12.1 and 12.2, for insulation of the connection, is placed over each of the corresponding connecting points.

A shrink-sleeve section 13 is used as an attachment element, holding the housing 11 on the cable run 8.1, in order to fix the housing 11 which, for example, may comprise two shell halves.

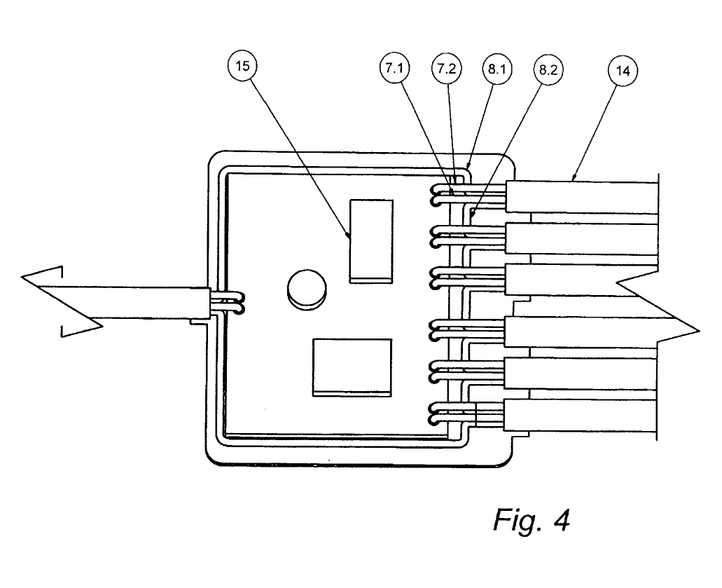

As can be seen in FIG. 4, the cable runs 8.1 and 8.2 and the connecting cables 7.1 and 7.2 are routed jointly in one cable sheath 14 to a multiplexer 15. A plurality of wear indicators with associated temperature sensors are preferably connected to the multiplexer 15, in the illustrated example the braking system of a three-axle trailer.

A unit 16, comprising cable runs 8.1 and 8.2 as well as connecting cables 7.1 and 7.2, and/or radio transmission as well, then lead to the signal store from the multiplexer 15. The individual supply lines are checked continuously or periodically in the multiplexer, and their signals are then supplied via the unit 16 to the signal store. This minimizes the wiring complexity.

### Patent Attorneys

### European Patent Attorney

### File reference: P 3642/PCT Date: Dec. 15, 2006 W/ST/VI

List of reference symbols

| | |
|---|---|
| 1 | Housing |
| 2 | Indicator cable |
| 3 | End surface |
| 4 | Loop |
| 5 | Guide |
| 6 | Temperature sensor |
| 7 | Connecting cable |
| 8 | Cable run |
| 9 | Clamping element |
| 10 | Space |
| 11 | Housing |
| 12 | Insulator |
| 13 | Attachment element |
| 14 | Cable sheath |
| 15 | Multiplexer |
| 16 | Unit |

1. A braking system for a vehicle having at least one brake pad, which may have at least one associated wear indicator, with the braking system and/or the wear indicator having at least one associated temperature sensor (6), characterized in that the at least one temperature sensor (6) has at least one associated cable run (8.1, 8.2) of an indicator cable (2).

2. The braking system as claimed in claim 1, characterized in that the temperature sensor (6) is integrated in the wear indicator.

3. The braking system as claimed in claim 1 or 2, characterized in that the temperature sensor (6) is arranged within a loop (4) which is formed by the indicator cable (2).

4. The braking system as claimed in one of claims 1 to 3, characterized in that a connecting cable (7) which passes from the temperature sensor (6) to a signal store or monitoring unit, is passed between cable runs (8.1, 8.2) of the indicator cable (2) from the wear indicator.

5. The braking system as claimed in at least one of claims 1 to 4, characterized in that the temperature sensor (6) is associated with the indicator cable within a housing (1) of the wear indicator.

6. The braking system as claimed in at least one of claims 1 to 4, characterized in that the temperature sensor (6) is associated with the indicator cable (2) outside a housing (1) of the wear indicator.

7. The braking system as claimed in claim 6, characterized in that the temperature sensor (6) is arranged in a housing (11) which fixes the temperature sensor (6) on the indicator cable (2) such that the temperature sensor (6) is aligned with respect to the indicator cable (2).

8. The braking system as claimed in claim 7, characterized in that the housing (11) is fixed to the indicator cable (2) via an attachment element (13).

9. The braking system as claimed in at least one of claims 1 to 8, characterized in that a connecting cable (7) of the temperature sensor (6) is connected to a multiplexer (15) for a signal store, possibly together with an indicator cable (2), upstream of the signal store.

10. The braking system as claimed in claim 9, characterized in that a plurality of connecting cables (7) open into the multiplexer (15), or the symbols are transmitted by radio, but this is connected to the signal store only via one or more signal cables (16) or is connected to the signal store by radio.

11. The braking system as claimed in claim 9 or 10, characterized in that a plurality of indicator cables (2) open into the multiplexer (15), but these cables are connected only via one or more signal cables (16) or by radio to a signal store for the signals which are transmitted via the indicator cables.

12. A method for monitoring a braking system for a vehicle having at least one brake pad, which has at least one associated wear indicator, with the braking system and/or the wear indicator having at least one associated temperature sensor (6), characterized in that the temperature sensor (6) is associated with at least one cable run (8.1, 8.2) of an indicator cable (2), and a temperature of the wear indicator itself and/or of its peripheral and/or of the indicator cable (2) is monitored.

13. The method as claimed in claim 12, characterized in that the temperature of a plurality of wear indicators and/or their peripherals and/or the indicator cable (2) is checked successively at time intervals.

14. A wear indicator for monitoring the wear of a brake pad having a housing (1) and an indicator cable (2), characterized in that the housing (1) and/or the indicator cable (2) have/has an associated temperature sensor (6), with the temperature sensor (6) being associated with at least one cable run (8.1, 8.2) of the indicator cable (2).
